(19) United States
(12) Patent Application Publication
(10) Pub. No.: US 2024/0347716 A1
(43) Pub. Date: Oct. 17, 2024

(54) LITHIUM ION BATTERY ELECTRODES COMPOSITION AND PROCESS OF ITS PREPARATION THEREOF

(71) Applicant: Indian Oil Corporation Limited, Mumbai (IN)

(72) Inventors: Palanichamy Sennu, Faridabad (IN); Veena Yadav, Faridabad (IN); Krishnan Senthilkumar, Faridabad (IN); Devotta Irudayaraj, Faridabad (IN); Umish Srivastva, Faridabad (IN)

(73) Assignee: Indian Oil Corporation Limited, Mumbai (IN)

(21) Appl. No.: 18/634,740

(22) Filed: Apr. 12, 2024

(30) Foreign Application Priority Data
Apr. 12, 2023 (IN) 202321027120

(51) Int. Cl. H01M 4/485; H01M 4/02; H01M 4/04; H01M 4/1391; H01M 4/62; H01M 4/66; H01M 10/0525

(52) U.S. Cl. CPC H01M 4/485; H01M 4/0404; H01M 4/1391; H01M 4/623; H01M 4/625; H01M 4/661; H01M 10/0525; H01M 2004/027; H01M 2004/028

(57) ABSTRACT

The present invention relates to a high rate capable lithium ion battery/cell with carbon fused metal and hetero atom doped multi walled carbon nanotubes (MWCNT) as conductive carbon for electrode is fabricated. Cathode electrode is prepared with active material along with high interfacial area carbon fused metal and heteroatom doped MWCNT prepared from petroleum refinery feed stock wherein metal is transition metal like Co, Mn, Fe etc. and heteroatom is nitrogen, sulphur, oxygen, phosphorus etc. Active material is selected from may comprise NMC, LFP, NCA, LNMO, LCO, LMO or combination thereof. Lithium ion full cells of 2032 coin cells were fabricated using the above materials as cathode with graphite anode is high rate capable of deliver capacity up to 5 C rate, deliver specific capacity of 80-100 mAhg−1 at 1 C rate and exhibit good cycling stability at same rate when cycled between 2.75-4.2V.

### FIELD OF THE INVENTION

The present disclosure relates to fabrication of high rate capable lithium ion battery and process for preparation of its electrodes using carbon fused metal and hetero atom doped multi walled carbon nanotubes. More particularly, the present invention relates to a cathode electrode for Lithium ion battery and a process for preparation thereof. Cathode is prepared with active material, carbon black and indigenously prepared carbon fused metal and hetero atom doped Multi walled carbon nanotubes (MWCNT). MWCNT is prepared from petroleum refinery feed stock. MWCNT is metal and heteroatom doped CNT wherein metal is transition metal like Co, Mn, Fe, Ni etc. and heteroatom is nitrogen, sulphur, oxygen, phosphorus etc. Polymer binder is also used in the composition to prepare cathode electrode.

### BACKGROUND OF THE INVENTION

Carbon with high surface area plays a key role in the performance of battery. Interfacial surface area between carbon and active material generally affects the internal resistance of interparticle, rate capability and other properties of electrode. Along with surface area of carbon, adhesion property of the same is very crucial as it enhance life cycle of battery without deterioration of active material and capacity decay. Although, many efforts have been made to improve performance of battery using different types of high surface area carbon material but still there is a need to develop lithium ion battery that will increase the rate capability, power density along with high cycle life without loss of capacity.

MWCNT have many unique properties derived from small sizes, cylindrical graphitic structure and high aspect ratios. Carbon nanotubes have extremely high tensile strength, high modulus, good chemical and environmental stability and high thermal and electrical conductivity. Carbon nanotubes have found many applications, including the preparation of conductive, electromagnetic and high-strength composites, energy storage systems etc. In batteries MWCNT may act as conductive agent in cathode and anode electrode. MWCNT may also act as active anode material of lithium ion batteries.

Carbon fused metal and hetero atom doped MWCNT has higher interfacial surface area thereby it connects with active material also which leads to higher conductivity and adhesion property of electrode required for highly stable and high rate capable cathode electrode of lithium ion battery.

US20140093769A1 provides nano element-based electrode materials for rechargeable batteries. The electrodes are based on a carbon nanotube (CNT) scaffold that is coated with a thin layer of electrochemically active material in the form of nanoparticle. The use of alternating layers of CNT and active nanoparticles further increases the power density and rate of the batteries.

U.S. Pat. No. 8,540,902B2 describes carbon-nanotube based pastes and methods for its making and using. Carbon nanotubes are dispersed via milling; resultant paste has Hegman scale of greater than 7. The pastes can be used as electro-conductivity enhancement in electronic devices such as batteries, capacitors, electrodes or other devices needing high conductivity paste.

US20070190422A1 pertains to energy storage devices. In particular, this disclosure relates to lithium-ion batteries having two active electrodes composed of carbon nanotube (CNT) material, wherein lithium metal powder is dispersed in the CNT material of the anode.

EP3786110A1 relates to carbon nanotubes dispersion excellent in dispersibility of carbon nanotubes and storage stability. This disclosure also relates to a battery electrode mixture layer and a lithium ion secondary battery containing the carbon nanotube dispersion.

U.S. Pat. No. 8,822,078B2 relates to freestanding carbon nanotubes paper comprising purified carbon nanotubes, Where the purified carbon nanotubes form the freestanding carbon nanotube paper and carbon microparticles are embedded in and/or present on a surface of the carbon nanotube paper. This disclosure also relates to a lithium ion battery, capacitor, supercapacitor, battery/capacitor, and fuel cell containing the freestanding carbon nanotube paper as an electrode.

US20050181282A1 discloses Carbon Nanofiber-based (CNT-Carbon Nanotube) electrical high performance battery comprising a cell trough filled with electrolyte, a spring coil locking onto said cell trough, an anode/cathode substrate plate installed within said cell trough with its separation membrane, and positive and negative terminals installed outside the cell cap connecting to said anode/cathode substrate plate respectively.

US20090246625A1 is directed to lithium-ion batteries in general and more particularly to lithium-ion batteries based on aligned graphene ribbon anodes, V₂O₅ graphene ribbon composite cathodes, and ionic liquid electrolytes. The lithium-ion batteries have excellent performance metrics of cell voltages, energy densities, and power densities.

US20110256451A1 discloses an electronic device comprising: a carbon nanotube film having a plurality of carbon nanotubes; an inorganic coating on the carbon nanotube film; and a conductive electrode coupled to the carbon nanotube film for conducting current therefrom.

CN105375009A discloses a stable type nitrogen-doped carbon nanometer pipe and iron oxide composite negative pole material, based on nitrogen-doped carbon nanometer pipe, it is characterized in that: the outer surface load of described nitrogen-doped carbon nanometer pipe has iron oxide particles, wherein iron oxide is main component, and the load capacity of iron oxide accounts for the 10-90% of iron oxide particles and nitrogen-doped carbon nanometer pipe gross mass.

US20160020466A1 relates to a dispersion comprising a dispersion medium, a polymeric dispersing agent, and carbon nanotubes dispersed in the dispersion medium.

U.S. Pat. No. 10,622,631B2 comprises the negative active material crystalline carbon comprising natural graphite, artificial graphite, expandable graphite, graphene, carbon nanotubes, or a combination thereof along with silicon-carbon secondary particles.

EP 3404747A1 describes compositions for preparing expander free electrodes for lead acid battery and performance thereof. It deals with employing heteroatoms namely Nitrogen, Sulphur intrinsic embedded carbon nanotubes (H-CNT) as multifunctional additive for preparing lead acid battery electrodes to substitute the expander chemicals namely, vanisperse, Dinel fibre, barium sulphate and carbon black.

Ruan, Boyang, et al. Carbon-encapsulated Sn@N-doped carbon nanotubes as anode materials for application in SIBs. ACS applied materials & interfaces 9.43 (2017): 37682-37693. discloses carbon fused Sn@N-doped carbon nanotubes as anode materials for application in sodium ion battery.

High rate capability and cycle life issue of lithium ion battery still remains an issue due to low conductivity of conductive carbon used in lithium ion battery electrodes. Also, safety of Lithium ion batteries remains a challenge. Therefore, it remains the need of the hour to resolve drawbacks associated with Lithium ion batteries.

### OBJECTIVES OF THE INVENTION

It is the primary objective of the present invention to provide a high rate capable lithium ion battery.

It is further objective of the present invention is to disclose a process for preparation of its electrodes using carbon fused metal and hetero atom doped multi walled carbon nanotubes.

### SUMMARY OF THE INVENTION

The present invention as embodied and broadly described herein provides a cathode electrode that comprises carbon fused metal and hetero atom doped MWCNT prepared from refinery feed, active material, carbon black and polymer binder. The resultant electrode obtained through the process of the present invention results in effectively overcoming the problem of high rate capability and cycle life issue of lithium ion battery/cell due to low conductivity of conductive carbon used in lithium ion battery electrode. Present invention also improves the safety of lithium ion battery as it uses MWCNT which has high thermal conductivity leads to heat dissipation throughout the electrode properly thereby avoid thermal runaway which is very common in lithium ion battery.

The present invention provides a cathode electrode for Lithium ion battery comprising:
a) carbon fused metal and hetero atom doped multi walled carbon nanotubes (MWCNT);
b) active material;
c) carbon black; and
d) polymer binder.

In one of the features of the present invention, the cathode active material present in the cathode electrode composition is in the range of 85-95% by weight of the composition. Carbon fused metal and heteroatom doped MWCNT present in the cathode electrode composition is in the range of 0.5-6% by weight of the composition. Carbon black present in the range of 0.5-6% by weight of composition. Polymer binder is present in the range of 1-5% by weight of composition.

The present invention also provides a process for preparing a cathode for Lithium ion battery comprising the preparation of metal and hetero atom doped MWCNT from refinery feedstock followed by the preparation of higher interfacial carbon fused metal and hetero atom doped MWCNT further followed by the preparation of Cathode Electrode Slurry and finally the preparation of Cathode Electrode.

The present invention also provides a process for preparing a cathode electrode for Lithium ion battery comprising the steps of:
a). preparing of a metal and hetero atom doped MWCNT from a refinery feedstock;
b). preparing of a carbon fused metal and hetero atom doped MWCNT from above obtained metal and hetero atom doped MWCNT;
c). preparing a Cathode Electrode Slurry by mixing 85-95% by weight of an active material with 0.5-6% by weight of the carbon fused metal and hetero atom doped MWCNT followed by mixing with 0.5-6% by weight of carbon black to obtain a mixture and then adding 1-5% by weight of a polymer binder to the above mixture; and
d). fabricating of Cathode Electrode.

In another feature, the present invention provides a Lithium ion battery comprising:
a) cathode electrode made of active material, carbon fused metal and hetero atom doped MWCNT, carbon black and polymer binder; and
b) graphite anode.

The present invention also provides novel electrode composition of lithium ion battery with high rate capability and high cycle life.

Carbon fused metal doped hetero atom MWCNT has good adhesion properties which lead to stable life cycle without capacity decay.

Carbon fused metal doped hetero atom MWCNT indigenously produced from crude oil and its product is lesser in cost as compared to MWCNT prepared by pure gaseous molecule.

### BRIEF DESCRIPTION OF THE FIGURES

The presented invention will be deciphered correctly when read in conjunction with the appended figures. The description of the figure embodiments is given herein.

FIG. 1 illustrates Raman Shift graph of carbon fused metal and hetero atom doped MWCNT.

FIG. 2 illustrates XRD graph of carbon fused metal and hetero atom doped MWCNT.

FIG. 3 illustrates TGA graph of carbon fused metal and hetero atom doped MWCNT.

FIG. 4 illustrates Cyclic Voltammetry graph of LiFePO₄ cathode doped with carbon fused metal and hetero atom doped MWCNT.

FIG. 5 illustrates low resolution TEM image of carbon fused metal and hetero atom doped MWCNT (low magnification).

FIG. 6 illustrates HR-TEM image of carbon fused metal and hetero atom doped MWCNT (high magnification).

FIG. 7 illustrates Rate capability comparison graph of NMC 811 cathode doped with carbon fused metal and hetero atom doped MWCNT with control case.

FIG. 8 illustrates Rate capability comparison graph of NCA cathode doped with carbon fused metal and hetero atom doped MWCNT with control case.

FIG. 9 illustrates Life cycle comparison of NMC 811 cathode doped with carbon fused metal and hetero atom doped MWCNT with control case and commercial MWCNT.

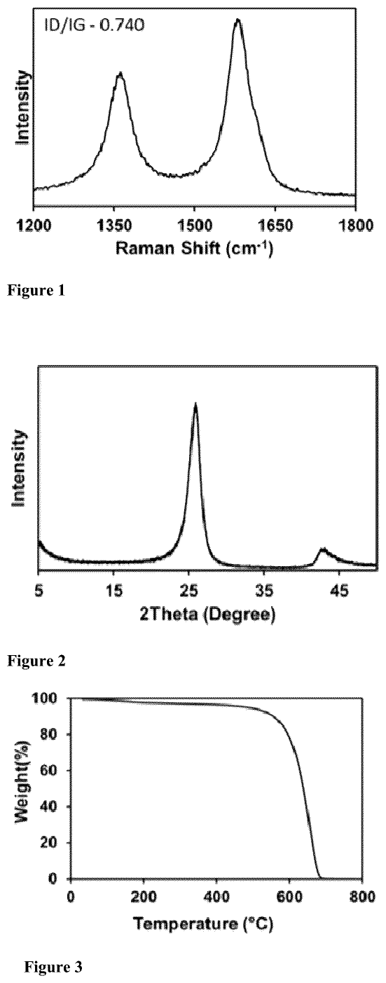

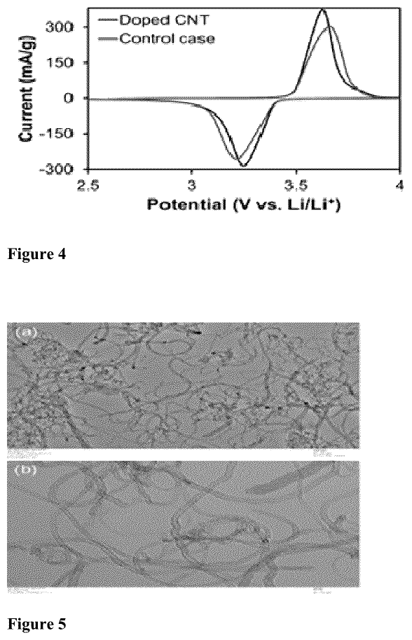

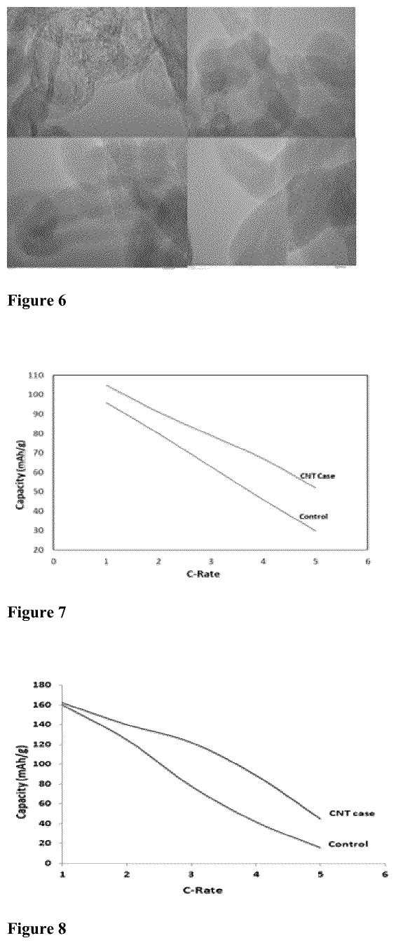

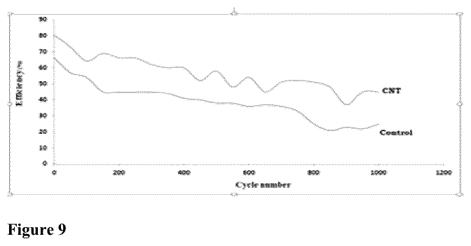

### DETAILED DESCRIPTION OF THE INVENTION

It should be understood at the outset that although illustrative implementations of the embodiments of the present disclosure are illustrated below, the present invention may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

Unless otherwise defined, all technical and scientific terms used herein have the same meaning as commonly understood by one of ordinary skill in the art to which this invention belongs.

The terminology and structure employed herein is for describing, teaching and illuminating some embodiments and their specific features and elements and does not limit, restrict or reduce the scope of the claims or their equivalents.

“Doctor blade” as used in the invention is a tool to coat desired thickness of electrode material.

“Active material” as defined in the invention is capacity carrying material of battery i.e Lithium based metal oxides.

“Crude oil related product” or “Refinery feedstock” as defined in the invention refers to Heavy naphtha, Lighter naphtha and combination thereof.

“ID/IG” ratio as used in invention is used to define defects in carbon sample. If ID/IG ratio is more, defects are more in carbon sample and vice versa.

The present invention provides a cathode electrode for Lithium ion battery comprising:
a) carbon fused metal and hetero atom doped multi walled carbon nanotubes (MWCNT);
b) active material;
c) carbon black; and
d) polymer binder.

In one of the features of the present invention, the carbon fused metal and heteroatom doped MWCNT is present in the range of 0.5-6 wt %.

In another feature of the present invention, the active material is selected from Lithium Nickel-Manganese-Cobalt Oxide (NMC), Lithium Nickel-Cobalt-Aluminum Oxide (NCA) and Lithium iron phosphate (LFP), Lithium Nickel Manganese Spinel (LNMO), Lithium Manganese Oxide (LMO) and Lithium Cobalt Oxide (LCO) and is present in the range of 85-95 wt %.

In yet another feature of the present invention, the carbon black is present in the range of 0.5-6 wt %.

In yet another feature of the present invention, the polymer binder is Polyvinylidene fluoride in the range of 1-5 wt %.

The present invention also provides a process for preparing a cathode electrode for Lithium ion battery, the process comprising the steps of:
a). preparing of a metal and hetero atom doped MWCNT from a refinery feedstock;
b). preparing of a carbon fused metal and hetero atom doped MWCNT from above obtained metal and hetero atom doped MWCNT;
c). preparing a cathode Electrode Slurry by mixing 85-95% by weight of an active material with 0.5-6% by weight of the carbon fused metal and hetero atom doped MWCNT followed by mixing with 0.5-6% by weight of carbon black to obtain a mixture and then adding 1-5% by weight of a polymer binder to the above mixture; and
d). fabricating of cathode Electrode.

In one of the features of the present invention, the step (a) of the above process comprises:
I. reducing a catalyst using hydrogen gas in a reactor operating at three different temperatures zones at about 620-640° C., 645-665° C. and 670-690° C. and at pressure of about 1 atmosphere;
II. feeding refinery feedstock into the reactor with a flow rate of 25-45 ml/hr for 10 hrs in the presence of nitrogen carrier gas;
III adding 0.1-1 gm of doped MWCNTs and dilute sulphuric acid (50-550 ml) and dispersed for 0.5-1 hr to obtain a mixture;
IV. refluxing the mixture of step III at 80-100° C. for 2-6 hrs with the speed of 200-500 rpm to obtain a reaction mixture;
V. adding distilled water to the reaction mixture of step IV and keeping for 10-15 mins followed by decanting and filtering it; and
VI. after repeating step V 4-5 times, the obtained mixture is washed to neutral pH, followed by drying at 100-120° C. for 8-12 hrs and weighing to obtain the metal and hetero-atom doped MWCNT.

In another feature of the present invention, the step (b) of the process for preparing the cathode electrode for Lithium ion battery comprises:
I. milling 1-20 gm of carbon black along 80-99 gm of metal and hetero atom doped MWCNT together to obtain a powder;
II. the powder obtained in step I is sonicated in NMP solvent for 0.5-1 hr to obtain a resultant mixture;
III. filtering the resulting mixture and then drying and calcining to obtain carbon fused metal and hetero atom doped MWCNT.

In yet another feature of the present invention, the step (c) of the process for preparing the cathode electrode for Lithium ion battery comprises:
I. mixing the carbon fused metal and hetero atom doped MWCNT with the active material, and then adding carbon black to obtain the mixture, wherein the active material is selected from NMC, NCA, LFP, LNMO, LMO and LCO and combination thereof;
II. taking a polymer binder in NMP solution and adding to above mixture and stirring it for 2-8 hrs to get homogenous cathode electrode slurry.

In yet another feature of the present invention, the step (d) of the process for preparing the cathode electrode for Lithium ion battery comprises:
I. coating the cathode electrode slurry over aluminum foil with applicator thickness 100-300 mm; and
II. putting the cathode electrode of step I into vacuum oven at 100-120° C. overnight for drying to obtain the cathode for Lithium ion battery.

In yet another feature of the present invention, the metal and hetero atom doped MWCNT comprises Co: 0.01-3100 ppm, Mn: 0.01-800 ppm, Fe: 0.01-400 ppm, S: 0.001-1 wt % and N: 0.01-2000 ppm.

The present invention also provides a Lithium ion battery comprising:
a) cathode electrode made of active material, carbon fused metal and hetero atom doped MWCNT, carbon black and polymer binder; and
b) graphite anode.

In one of the features of the present invention, the Lithium ion battery delivers capacity up to 5 C rate, the cell delivers specific capacity of 80-100 mAhg⁻¹ at 1 C rate, and the cell exhibits excellent cycling stability when cycled between 2.75-4.2V.

The present disclosure relates to fabrication of high rate capable lithium ion battery and process for preparation of its electrodes using carbon fused metal & hetero atom doped multi walled carbon nanotubes. Cathode is prepared with active material, carbon black and indigenously prepared carbon fused doped MWCNT. MWCNT is prepared from petroleum refinery feed stock. MWCNT is metal & heteroatom doped CNT wherein metal is transition metal like Co, Mn, Fe, Ni etc. and heteroatom is nitrogen, sulphur, oxygen, phosphorus etc. Polymer binder is also used in the composition to prepare cathode electrode.

In one of the embodiments, present invention discloses the process for the preparation and composition of lithium ion cell electrodes. Cathode active material present in the cathode electrode composition is in the range of 85-95% by weight of the composition. Carbon fused metal and heteroatom doped MWCNT present in the cathode electrode composition is in the range of 0.5-6% by weight of the composition. Carbon black is present in the range of 0.5-6% by weight of composition. Polymer binder is present in the range of 1-5% by weight of composition.

Refinery feedstock in the present invention comprises low sulphur crude oil, high sulphur crude oil and mixture thereof.

In one of another embodiments, present invention comprises following process for the preparation of cathode electrode comprising the steps of:
1). Preparation of metal and hetero atom doped MWCNT from refinery feedstock involves following:
1a). Hydrogen gas was used to reduce catalyst in reactor. After that crude oil related product was fed into the reactor. Reactor was operating at three temperature zone maintained at about 630° C., 655° C. and 680° C. The reactor is operated at pressure of about 1 atmosphere. The catalyst used in the process is alumina supported Fe—Co catalyst or Fe—Mo catalyst.

Metal and hetero atom doped MWCNT with OD (outer diameter): 20-40 nm, ID (inner diameter): 5-17 nm, with 15-40 layers or more can be prepared from refinery feed stock by process as described below:

8 g of alumina supported catalyst is loaded inside the middle of vibrating reactor. The flow rate of carrier and reducing gases are controlled through the electronic mass flow meters and temperature of catalyst and reactor is measured through the thermocouple. Further catalyst is heated up to 700° C., in presence of nitrogen carrier gas. After attaining the desired temperature of 700° C., hydrogen gas (75 sccm) is introduced into the reactor in order to reduce the catalyst and reduction is continued for 4 hrs. After the completion of catalyst reduction, reactor temperature is decreased to 600° C. in the nitrogen atmosphere. At this stage, high sulphur crude oil having sulphur content of >1 wt. % is fed into the reactor at a flow rate of 14 g/h with 50 sccm of nitrogen carrier gas and is continued for 430 min. The product gas stream is further analyzed by refinery gas analyzer. The chromatogram shows yield pattern of gases such as hydrogen, nitrogen, methane and other lighter hydrocarbons. After the completion of run, reactor is cooled in nitrogen atmosphere and solid carbon nanotubes collected and yield is estimated.
1b). Required quantity of doped MWCNTs prepared by above method (0.1-1 gm) and diluted sulphuric acid (50-550 ml) were added into a round-bottomed glass flask, and the MWCNT were dispersed for 0.5-1 hrs in an ultrasonic bath. After that, same mixture was refluxed on hot plate at 80-100° C. for 2-6 hrs at the speed of 200-500 rpm. Then, distilled water was added to the same flask and kept it as such for 10-15 mins and then decant it and then sample was filtered on a membrane filter and repeat the same for 4-5 times. After that washed to neutral pH, dried at 100-120° C. for 8-12 hrs, and weighed to obtain desired metal and hetero-atom doped MWCNT. (Co: 0.01-3100 ppm, Mn: 0.01-800 ppm, Fe: 0.01-400 ppm, S: 0.001-1 wt % and N: 0.01-2000 ppm).
2). Preparation of higher interfacial carbon fused metal and hetero atom doped MWCNT:
   2a). 10 gm of carbon black along with 90 gm of metal and hetero-doped MWCNT was milled together in ethanol solvent with the help of planetary ball mill at a speed of 500 rpm at room temperature in a planetary ball mill for 1-4 hrs.
   2b). Filtration of resulting mixture and then mixture was kept in vacuum oven at 200° C. for 6-10 hrs.
   2c). Powder was kept in furnace at 1000-1400° C. in inert atmosphere. Heating ramp rate of 200° C./hr was given until to attain 1000-1400° C. temperature and then hold the same temperature up to 2-4 hrs followed by natural cooling to room temperature.
   2d). Flow rate of argon gas was kept at 100 ml/hr throughout the entire process.
3). Preparation of Cathode Electrode Slurry:
3a). Cathode active material (NMC/NCA/LFP, LNMO, LCO and LMO etc) was taken 85-95% by weight of the composition and mixed with 0.5-6% by weight of carbon fused metal and hetero atom doped MWCNT with the help of mortar pestle/vacuum mixer for 15 mins-1 hr. Then the resulting powder mixture was further mixed with 0.5-6% by weight of carbon black and grinded for 15 mins-1 hr.
3b). 1-5% polymer binder Polyvinylidene fluoride (PVDF) by weight of total composition in NMP (N-methyl-2-pyrrolidone) solution was added to above and stirred it on magnetic stirrer for 2-8 hrs to get homogenous slurry.
4). Fabrication of Cathode Electrode:
4a). Cathode slurry prepared as above was coated over aluminum foil with the help of doctor blade applicator with applicator of thickness 100-300 mm. Cathode electrode was then put into vacuum oven at 100-120° C. overnight for drying.

In one of more embodiments, invention discloses the use of low grade carbon black which is very cheap conductive material available in market along with metal doped hetero atom MWCNT for lithium ion battery application.

In furthermore embodiments, present invention discloses use of carbon fused metal and heteroatom doped MWCNT with ID/IG: 0.740±0.1, 30-40 layers along with carbon black in electrodes to make full lithium ion cell with high rate capability.

In another more embodiments, present invention discloses use of carbon fused metal and heteroatom doped MWCNT with BET surface area 120±10 m²/gm along with carbon black in electrodes to make full lithium ion cell with high rate capability.

In one more embodiments, present invention discloses use of highly purified carbon fused metal and heteroatom doped MWCNT (confirmed by TGA) along with carbon black in electrodes to make full lithium ion cell with high rate capability.

In another more embodiment, present invention discloses use of highly graphitic carbon fused metal and heteroatom doped MWCNT (confirmed by XRD) along with carbon black in electrodes to make full lithium ion cell with high rate capability.

According to an aspect of subject matter, in said embodiment the carbon coated metal doped hetero atom MWCNT has higher interfacial surface area (confirmed by CV electrochemical studies) thereby it connects active material also which leads to higher conductivity and adhesion property of electrode required for highly stable and high rate capable cathode electrode of lithium ion battery.

In yet another embodiment, present invention provides formation of lithium ion battery with high Coulombic efficiency.

According to an aspect of subject matter, in said embodiment the optimized composition of carbon fused metal and hetero atom doped MWCNT in cathode electrode avoid the irreversibility capacity lose.

In one preferred embodiment, present invention discloses the fabrication of full lithium ion coin cell with high power density and high rate capability.

In another more preferred embodiment, invention discloses the preparation of cathode with carbon fused MWCNT prepared from petroleum refinery feed stock. MWCNT is metal & heteroatom doped CNT wherein metal is heavy metal like Co, Mn, Fe, Ni etc. and heteroatom is nitrogen, oxygen, sulphur, phosphorus etc.

In furthermore preferred embodiment, invention discloses fabrication of full cells of 2032 coin cells using the above materials is high rate capable of delivering capacity up to 5 C rate, deliver specific capacity of 80-100 mAhg⁻¹ at 1 C rate and exhibit excellent cycling stability when cycled between 2.75-4.2V.

### Advantage and Improvements of the Present Invention Over the Existing Methods

1. Carbon fused metal and hetero atom doped MWCNT prepared from petroleum refinery feed stock can be used along with low quality cheap carbon black which are not suitable for lithium ion battery application.
2. Carbon fused metal and hetero atom doped MWCNT particles are compatible with low quality carbon black and lead to higher interfacial interaction between their particles and active material particles as well.
3. This interaction also helps to enhance the adhesion property of the active material which leads to stable cathode with high rate, high life cycle.

### EXAMPLES

The present invention is now being illustrated by way of non-limiting examples.

### Example 1: Preparation of Desired Metal and Hetero Atom Doped MWCNT from Refinery Feedstock

Hydrogen gas was used to reduce catalyst in reactor. Reactor was operating at three temperature zone maintained at about 630° C., 655° C. and 680° C. The reactor is operated at pressure of about 1 atmosphere. Crude oil related product was fed into the reactor with a flow rate of 35 ml/hr for 10 hrs in the presence of nitrogen carrier gas to get metal and hetero-atom doped MWCNT. 0.1-1 gm of produced doped MWCNTs and dilute sulphuric acid (50-550 ml) were added into a round-bottomed glass flask, and the MWCNT were dispersed for 0.5-1 hrs in an ultrasonic bath. After that, same mixture was refluxed on hot plate at 80-100° C. at the speed of 200-500 rpm. Then, distilled water was added to the same flask and kept for 10-15 mins and then decant it and the sample was filtered on a membrane filter, and repeat the same for 4-5 times then washed to neutral pH, dried at 100-120° C. for 8-12 hrs, and weighed to obtain desired metal and hetero-atom doped MWCNT (Co: 0.01-3100 ppm, Mn: 0.01-800 ppm, Fc: 0.01-400 ppm, S: 0.001-1 wt % and N: 0.01-200 ppm).

### Example 2: Preparation of Higher Interfacial Carbon Fused Metal and Hetero Atom Doped MWCNT

1. 10 gm of carbon black and 90 gm of metal and heteroatom doped MWCNT was milled together with the help of planetary ball mill at a speed of 500 rpm at room temperature in a planetary ball mill for 1-3 hrs and then resulting powder was sonicated in NMP solvent for 0.5-1 hrs.
2. Filtration of resulting mixture and then kept in vacuum oven at 200° C. for 6-10 hrs.
3. Powder was kept in furnace at 1000-1400° C. in inert atmosphere. Heating ramp rate of 200° C./hr was given until to attain 1000-1400° C. temperature and then hold the same temperature up to 2-4 hrs followed by natural cooling to room temperature.
4. Flow rate of argon gas was kept at 100 ml/hr throughout the entire process.

### Example 3: Preparation of NMC 811 Cathode Electrode

1.8 gm of cathode active material NMC 811 (Lithium Nickel-Manganese-Cobalt Oxide) was taken by and mixed with 68 mg of carbon fused metal and hetero atom doped MWCNT with the help of mortar pestle/vacuum mixer for 15 mins-1 hr then 24 mg carbon black was added and grinded for 15 mins-2 hrs. Then 52 mg of polymer binder by weight of total composition in 2.7 ml of NMP solution was added to above and stirred it on magnetic stirrer for 2-8 hrs to get homogenous slurry. Then cathode electrode was cut into discs of 16 mm diameter.

### Example 4: Preparation of NMC 811 Cathode Electrode

1.8 gm of cathode active material NMC 811 (Lithium Nickel-Manganese-Cobalt Oxide) was taken by and mixed with 88 mg of carbon fused metal and hetero atom doped MWCNT with the help of mortar pestle/vacuum mixer for 15 mins-1 hr then 32 mg carbon black was added and grinded for 15 mins-2 hrs. Then 82 mg of polymer binder by weight of total composition in 2.7 ml of NMP solution was added to above and stirred it on magnetic stirrer for 2-8 hrs to get homogenous slurry. Then cathode electrode was cut into discs of 16 mm diameter.

### Example 5: Preparation of NCA Cathode Electrode

1.8 gm of cathode active material NCA (Lithium Nickel-Cobalt Aluminum Oxide) was taken by and mixed with 68 mg of carbon fused metal and hetero atom doped MWCNT with the help of mortar pestle/vacuum mixer for 15 mins-1 hr then 24 mg carbon black was added and grinded for 15 mins-2 hrs. Then 82 mg of polymer binder by weight of total composition in 2.7 ml of NMP solution was added to above and stirred it under magnetic stirrer for 2-8 hrs to get homogenous slurry. Then cathode electrode was cut into discs of 16 mm diameter.

### Example 6: Preparation of NCA Cathode Electrode

1.8 gm of cathode active material NCA (Lithium Nickel-Cobalt Aluminum Oxide) was taken by and mixed with 88 mg of carbon fused metal and hetero atom doped MWCNT with the help of mortar pestle/vacuum mixer for 15 mins-1 hr then 32 mg carbon black was added and grinded for 15 mins-2 hrs. Then 82 mg of polymer binder by weight of total composition in 2.7 ml of NMP solution was added to above and stirred it under magnetic stirrer for 2-8 hrs to get homogenous slurry. Then cathode electrode was cut into discs of 16 mm diameter.

### Example 7: Preparation of LiFePO₄ Cathode Electrode

1.8 gm of cathode active material LiFePO₄ cathode (Lithium iron phosphate) (LFP) was taken by and mixed with 68 mg of carbon fused metal and hetero atom doped CNT with the help of mortar pestle/vacuum mixer for 15 mins-1 hr then 24 mg carbon black was added and grinded for 15 mins-2 hrs. Then 82 mg of polymer binder by weight of total composition in 2.7 ml of NMP solution was added to above and stirred it under magnetic stirrer for 2-8 hrs to get uniform homogenous slurry. Then cathode electrode was cut into discs of 16 mm diameter.

### Example 8: Preparation of LiFePO₄ Cathode Electrode

1.8 gm of cathode active material LiFePO₄ cathode (Lithium iron phosphate) (LFP) was taken by and mixed with 88 mg of carbon fused metal and hetero atom doped MWCNT with the help of mortar pestle/vacuum mixer for 15 mins-1 hr then 32 mg carbon black was added and grinded for 15 mins-2 hrs. Then 82 mg of polymer binder by weight of total composition in 2.7 ml of NMP solution was added to above and stirred it on magnetic stirrer for 2-8 hrs to get uniform homogenous slurry. Then cathode electrode was cut into discs of 16 mm diameter.

### Example 9: Fabrication/Testing of Lithium Ion 2032 Full Coin Cells Using Carbon Fused Metal and Hetero Atom Doped MWCNT Based NMC 811 Cathode

### 9a). Preparation of Cathode Electrode

1.8 gm of cathode active material NMC 811 (Lithium Nickel-Manganese-Cobalt Oxide) was taken and mixed with 48 mg of carbon fused metal and hetero atom doped MWCNT with the help of mortar pestle/vacuum mixer for 15 mins-1 hrs then 70 mg carbon black was added and grinded for 15 mins-2 hrs. Then 82 mg of polymer binder by weight of total composition in 2.7 ml of NMP solution was added to above and stirred it on magnetic stirrer for 2-8 hrs to get homogenous slurry. Then cathode electrode was cut into discs of 16 mm diameter.

### 9b). Preparation of Anode Electrode

Anode active material graphite 85-90% by weight of total composition was taken and mixed with 6% carbon black by weight of total composition with the help of mortal pestle/vacuum mixer for 15 mins-1 hr. 1-5% polymer binder by weight of total composition in NMP solution was added to above and stirred it on magnetic stirrer for overnight to get homogenous slurry. Then anode electrode was cut into discs of 16 mm diameter.

### 9c). Fabrication of Lithium Ion 2032 Coin Full Cells

CR2032 coin full cells were assembled in an argon filled glove box using graphite electrode as the anode, NMC 811 cathode electrode (as prepared above), polypropylene celgard polymer separator and the electrolyte consisting of 1-1.22 M of Lithium hexafluorophosphate various ratios of EC/EMC/DMC organic solvent along with additive vinylene carbonate (VC). Coin cells were charged/discharged cycled between 2.75 to 4.2 V on biologic BCS 805 battery cycler. Fabricated 2032 full coin cells were tested under various rates for rate capability studies.

| | | | | Carbon fused metal |
|---|---|---|---|---|
| | | | Control | and heteroatom |
| | | | case | doped MWCNT |
| Cathode | Anode | Rate | capacity | case capacity |
| Electrode | Electrode | Capability | (mAh/g) | (mAh/g) |
| NMC 811 | Graphite | 1C | 75 | 80 |
| NMC 811 | Graphite | 2C | 58 | 66 |
| NMC 811 | Graphite | 3C | 39 | 49 |
| NMC 811 | Graphite | 4C | 17 | 24 |

Doped MWCNT prepared from refinery feed stock showed high rate capability in lithium ion 2032 full coin cells.

### Example 10: Life Cycle Comparison of Doped MWCNT with Commercial MWCNT and Control Case in Lithium Ion Full Cell

Anode and cathode electrodes were prepared in similar way as prepared in example 1. CR2032 coin full cells were assembled in argon filled glove box using graphite electrode (as prepared above) as the anode, polypropylene celgard polymer separator and the electrolyte consisting of 1-1.22 M of Lithium hexafluorophosphate various ratios of EC/EMC/DMC organic solvent along with additive vinylene carbonate (VC). Coin cells were charged/discharged cycled between 2.75 to 4.2 V on biologic BCS 805 battery cycler. Fabricated 2032 coil full cells were tested for life cycle studies. Capacity observed at 1 C rate of the fabricated full cells during cycling is given as below.

| | | | Capacity |
|---|---|---|---|
| Cathode Electrode | Anode | | (mAh) after |
| (NMC 811) | Electrode | Rate | 680 cycles |
| Control case | Graphite | 1C | 63 |
| Carbon Fused Doped | Graphite | 1C | 73 |
| MWCNT | | | |
| Commercial MWCNT-1 | Graphite | 1C | 46 |
| Commercial MWCNT-2 | Graphite | 1C | 37 |

### Example 11: Capacity Retention Comparison of Novel Doped MWCNT with Control Case and Commercial MWCNT in Lithium Ion Cells

Anode and cathode electrodes were prepared in similar way as prepared in example 1. CR2032 coin full cells were assembled in argon filled glove box using graphite electrode (as prepared above) as the anode, polypropylene celgard polymer separator and the electrolyte consisting of 1-1.22 M of Lithium hexafluorophosphate various ratios of EC/EMC/DMC organic solvent along with additive vinylene carbonate (VC). Coin cells were charged/discharged cycled between 2.75 to 4.2 V on biologic.

BCS 805 battery cycler. Fabricated 2032 coil full cells were tested for life cycle studies. Total retention capacity observed at 1 C rate of the fabricated full cells during cycling is given as below.

| | | | Capacity |
|---|---|---|---|
| | | | Retention |
| Cathode Electrode | Anode | | (%) after |
| (NMC 811) | Electrode | Rate | 680 cycles |
| Control case | Graphite | 1C | 62 |
| Carbon Fused Doped | Graphite | 1C | 73 |
| MWCNT | | | |
| Commercial MWCNT-1 | Graphite | 1C | 49 |
| Commercial MWCNT-2 | Graphite | 1C | 38 |

### Example 12: Rate Capability of NCA Cathode Electrode & its Comparison with Control Case

Cathode active material NCA (Lithium Nickel-Cobalt-Aluminum Oxide) was taken 85-95% by weight of the composition and mixed with 60-100 mg of carbon fused metal and hetero atom doped MWCNT with the help of mortar pestle/vacuum mixer for 15 mins-1 hr. Then, 1-5% polymer binder by weight of total composition in NMP solution was added to above and stirred it under magnetic stirrer for overnight to get uniform homogenous slurry. Then cathode electrode was cut into discs of 16 mm diameter. CR2032 half coin cells were assembled in an argon filled glove box using lithium foil as the anode, polypropylene celgard polymer separator and the electrolyte consisting of 1 M of Lithium hexafluorophosphate in various ratios of EC/EMC organic solvent along with additive vinylene carbonate (VC). Coin cells were charged/discharged cycled between 2.75 to 4.2 V on biologic BCS 805 battery cycler. Fabricated 2032 half coin cells were tested under various rates for rate capability studies.

| | | | Carbon fused metal |
|---|---|---|---|
| | | Control | and heteroatom |
| | | case | doped MWCNT |
| Cathode | Rate | capacity | case capacity |
| Electrode | Capability | (mAh/g) | (mAh/g) |
| NCA | C/20 | 184 | 242 |
| NCA | 1C | 77 | 172 |
| NCA | 2C | failed | 120 |
| NCA | 3C | failed | 80 |

Doped MWCNT prepared from refinery feed stock showed high rate capability in lithium ion 2032 half coin cells.

### Example 13: Fabrication/Testing of Lithium Ion 2032 Full Coin Cells Using Carbon Fused Metal and Hetero Atom Doped MWCNT

### 13a). Preparation of Cathode Electrode

Cathode active material NCA (Lithium Nickel-Cobalt Aluminum Oxide) was taken 85-95% by weight of the composition and mixed with 0.5-6% by weight of carbon fused metal and hetero atom doped MWCNT with the help of mortar pestle/vacuum mixer for 15 mins-1 hr then 0.5-6% by weight of carbon black was added and grinded for 15 mins-2 hrs. Then 1-5% polymer binder by weight of total composition in NMP solution was added to above and stirred it on magnetic stirrer for overnight to get homogenous slurry. Then cathode electrode was cut into discs of 16 mm diameter.

### 13b). Preparation of Anode Electrode

Anode active material graphite 85-90% by weight of total composition was taken and mixed with 6% carbon black by weight of total composition with the help of mortal pestle/vacuum mixer for 15 mins-1 hr. 1-5% polymer binder by weight of total composition in NMP solution was added to above and stirred it under magnetic stirrer for overnight to get homogenous slurry. Then anode electrode was cut into discs of 16 mm diameter

### 13c). Fabrication of Lithium Ion 2032 Full Coin Cells:

CR2032 full coin cells were assembled in an argon filled glove box using graphite electrode as the anode, NMC 811 cathode electrode (as prepared above), polypropylene celgard polymer separator and the electrolyte consisting of 1-1.22 M of Lithium hexafluorophosphate various ration of EC/EMC/DMC organic solvent along with additive vinylene carbonate (VC). Coin cells were charged/discharged cycled between 2.75 to 4.2 V on biologic BCS 805 battery cycler. Fabricated 2032 full coin cells were tested under various rates for rate capability studies.

| | | | Control | Carbon fused |
|---|---|---|---|---|
| | | | case | doped MWCNT |
| Cathode | Anode | Rate | capacity | case capacity |
| Electrode | Electrode | Capability | (mAh/g) | (mAh/g) |
| NCA | Graphite | 1C | 160 | 162 |
| NCA | Graphite | 2C | 125 | 140 |
| NCA | Graphite | 3C | 78 | 122 |
| NCA | Graphite | 4C | 42 | 89 |
| NCA | Graphite | 5C | 16 | 45 |

### Example 14: Higher Electrical Conductivity of Carbon Fused Doped MWCNT LiFePO₄ Cathode (Lithium Iron Phosphate) and its Comparison with Control Case

Cathode slurry was prepared by using LiFePO₄ (Lithium iron phosphate) active cathode material 85-95% by weight of the total composition then, mixed with 0.5-6% by weight of carbon fused metal and hetero atom doped MWCNT, 0.5-6% by weight of carbon black. Then, 1-5% polymer binder by weight of total composition in NMP solution was used to make cathode slurry. Before slurry preparation, carbon black is dispersed in NMP for 10 mins-0.5 hr with 2-5 mins rest interval. Then cathode electrode was cut into discs of 16 mm diameter. CR2032 coin cells with different composition of neat metal and hetero atom doped MWCNT was assembled in an argon filled glove box using cathode working electrode area 1.77 cm², lithium foil as the counter electrode, celgard polymer separator and the electrolyte consisting of 1-1.22 M Lithium hexafluorophosphate in various ratio of ethylene carbonate/diethylene carbonate organic solvent. Cyclic voltammetry (CV) tests were performed at a scan rate of 0.1 mVs⁻¹ between 2.5 to 4.0 V. Anodic/cathodic peak current (mA/g) observed from different percentage of neat metal & hetero atom doped MWCNT is given as below.

| | | Working | Working LFP |
|---|---|---|---|
| | | Electrode- | Electrode- |
| | | Control case | (Carbon fused |
| Electrolyte | Peak Current | (Carbon Black) | doped MWCNT) |
| Lithium | Anodic peak | 301 | 369 |
| hexafluorophosphate | current (mA/g) | | |
| Lithium | Cathodic peak | 254 | 284 |
| hexafluorophosphate | current (mA/g) | | |

The CV profile of carbon fused doped MWCNT-LFP electrode shows higher anodic and cathodic peak currents compared to control case. The potential interval between the two redox peaks for LFP-MWCNT electrode is smaller than control case, reflecting its small polarization, high Li-ions diffusion and low inner resistance. The superior electrical conductivity of carbon fused doped MWCNT facilitates the electron transfer and reduces the resistance during the Li-ions reversible reaction.

### Example 15: Higher Interfacial Area and Conductance of Carbon Fused Doped MWCNT LiFePO₄ (LFP) Cathode (Lithium Iron Phosphate) and its Comparison with Control Case

Cathode slurry was prepared by using LiFePO₄ (Lithium iron phosphate) active cathode material 85-95% by weight of the total composition then, mixed with 0.5-6% by weight of carbon fused metal and hetero atom doped MWCNT, 0.5-6% by weight of carbon black. Then, 1-5% polymer binder by weight of total composition in NMP solution was used to make cathode slurry. Before slurry preparation, carbon black is dispersed in NMP for 10 mins-0.5 hrs with 2-5 mins rest interval. Then cathode electrode was cut into discs of 16 mm diameter. CR2032 coin cells with different composition of neat metal and hetero atom doped MWCNT was assembled in an argon filled glove box using cathode working electrode area 1.77 cm², lithium foil as the counter electrode, celgard polymer separator and the electrolyte consisting of 1-1.22 M Lithium hexafluorophosphate in various ration of ethylene carbonate/diethylene carbonate organic solvent. Cyclic voltammetry (CV) tests were performed at a scan rate of 0.1 mVs⁻¹ between 2.5 to 4.0 V. Anodic/cathodic peak current (mA/g) observed from different percentage of neat metal & hetero atom doped MWCNT is given as below.

| | Working | Working LFP- |
|---|---|---|
| | Electrode- | Electrode |
| | Control case | (Carbon fused |
| Sample Name | (Carbon Black) | doped MWCNT) |
| Anodic Peak Potential (V) | 3.638 | 3.676 |
| Cathodic Peak Potential (V) | 3.251 | 3.217 |
| Peak Separation (mV) | 387 | 459 |

Anodic and cathodic peaks appear at ˜3.6 and ˜3.2 V, which correspond to the charge-discharge reaction of the Fe²⁺/Fe³⁺ redox couple. The peak separation between oxidation and reduction of redox couple in fused doped cathode electrode is 72 mV lower as compared to control case which shows that the carbon in fused doped cathode covers all the LFP cathode particles have high interfacial area and makes efficient electronic conduction during the electrochemical reaction.

1. A cathode electrode for Lithium ion battery comprising:
a) carbon fused metal and hetero atom doped multi walled carbon nanotubes (MWCNT);
b) active material;
c) carbon black; and
d) polymer binder.

2. The electrode as claimed in claim 1, wherein the carbon fused metal and heteroatom doped MWCNT is present in the range of 0.5-6 wt %.

3. The electrode as claimed in claim 1, wherein the active material is selected from Lithium Nickel-Manganese-Cobalt Oxide (NMC), Lithium Nickel-Cobalt-Aluminum Oxide (NCA) and Lithium iron phosphate (LFP), Lithium Nickel Manganese Spinel (LNMO), Lithium Manganese Oxide (LMO) and Lithium Cobalt Oxide (LCO) and is present in the range of 85-95 wt %.

4. The electrode as claimed in claim 1, wherein the carbon black is present in the range of 0.5-6 wt %.

5. The electrode as claimed in claim 1, wherein the polymer binder is Polyvinylidene fluoride in the range of 1-5 wt %.

6. A process for preparing a cathode electrode for Lithium ion battery, the process comprising the steps of:
a). preparing of a metal and hetero atom doped MWCNT from a refinery feedstock;
b). preparing of a carbon fused metal and hetero atom doped MWCNT from above obtained metal and hetero atom doped MWCNT;
c). preparing a cathode Electrode Slurry by mixing 85-95% by weight of an active material with 0.5-6% by weight of the carbon fused metal and hetero atom doped MWCNT followed by mixing with 0.5-6% by weight of carbon black to obtain a mixture and then adding 1-5% by weight of a polymer binder to the above mixture; and
d). fabricating of cathode Electrode.

7. The process as claimed in claim 6, wherein the step (a) comprises:
I. reducing a catalyst using hydrogen gas in a reactor operating at three different temperatures zones at about 620-640° C., 645-665° C. and 670-690° C. and at pressure of about 1 atmosphere;
II. feeding the refinery feedstock into the reactor with a flow rate of 25-45 ml/hr for 10 hrs in the presence of nitrogen carrier gas;
III. adding 0.1-1 gm of doped MWCNTs and dilute sulphuric acid (50-550 ml) and dispersed for 0.5-1 hr to obtain a mixture;
IV. refluxing the mixture of step III at 80-100° C. for 2-6 hrs with the speed of 200-500 rpm to obtain a reaction mixture;
V. adding distilled water to the reaction mixture of step IV and keeping for 10-15 mins followed by decanting and filtering it; and
VI. after repeating step V 4-5 times, the obtained mixture is washed to neutral pH, followed by drying at 100-120° C. for 8-12 hrs and weighing to obtain the metal and hetero-atom doped MWCNT.

8. The process as claimed in claim 6, wherein the step (b) comprises:
I. milling 1-20 gm of carbon black along 80-99 gm of metal and hetero atom doped MWCNT together to obtain a powder;
II. the powder obtained in step I is sonicated in NMP solvent for 0.5-1 hr to obtain a resultant mixture; and
III. filtering the resulting mixture and then drying and calcining to obtain carbon fused metal and hetero atom doped MWCNT.

9. The process as claimed in claim 6, wherein the step (c) comprises:
I. mixing the carbon fused metal and hetero atom doped MWCNT with the active material, and then adding carbon black to obtain the mixture, wherein the active material is selected from NMC, NCA, LFP, LNMO, LMO and LCO and combination thereof; and
II. taking a polymer binder in NMP solution and adding to above mixture and stirring it for 2-8 hrs to get homogenous cathode electrode slurry.

10. The process as claimed in claim 6, wherein the step (d) comprises:
I. coating the cathode electrode slurry over aluminum foil with applicator thickness 100-300 mm; and
II. putting the cathode electrode of step I into vacuum oven at 100-120° C. overnight for drying to obtain the cathode for Lithium ion battery.

11. The process as claimed in claim 7, wherein the metal and hetero atom doped MWCNT comprises Co: 0.01-3100 ppm, Mn: 0.01-800 ppm, Fe: 0.01-400 ppm, S: 0.001-1 wt % and N: 0.01-2000 ppm.

12. A Lithium ion battery comprising:
a) cathode electrode as claimed in claim 1; and
b) graphite anode.

13. The Lithium ion battery as claimed in claim 12, wherein the battery delivers capacity up to 5 C rate, the battery delivers specific capacity of 80-100 mAhg⁻¹ at 1 C rate, and the battery exhibits excellent cycling stability when cycled between 2.75-4.2V.
